(19) United States
(12) Patent Application Publication
(10) Pub. No.: US 2005/0050093 A1
(43) Pub. Date: Mar. 3, 2005

(54) Customized selection of a voice file for a web page

(75) Inventors: Steven Edward Atkin, Austin, TX (US); Janani Janakiraman, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/651,727

(22) Filed: Aug. 29, 2003

(51) Int. Cl. G06F 17/00

(52) U.S. Cl. 707/104.1

(57) ABSTRACT

A method, apparatus, and computer instructions for responding to a request for a Web page. The location of a client is identified in response to a request for a Web page from a client. A voice file is selected for the Web page using the location of the client to form a selected voice file. The selected voice file is associated with the Web page to form a customized Web page; and the customized Web page is sent to the client.

### BACKGROUND OF THE INVENTION

1. Technical Field

The present invention relates generally to an improved data processing system and in particular to a method and apparatus for managing requests for documents. Still more particularly, the present invention provides a method, apparatus, and computer instructions for associating voice files with Web pages.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach. In offering goods and services, many businesses employ advertisements within Web pages. These advertisements may include various multimedia features including animated graphics, video, and audio. Many online advertisements are associated with voice files, also referred to as voice snippets. Currently, customization of advertising, including voice snippets, may be based on a particular user. Many Web sites encourage a user to register with the Web site by providing additional features or access if the user registers. This registration in many cases may be free to entice the user to provide information such as geographic location, gender, age and consumer preferences. When a user logs back into the Web site, advertisements on a Web page may be dynamically tailored to the user based on the registration information. Such a feature is useful when a user registers with a Web site and provides information. In many cases, however, users do not register with Web sites for various reasons, such as privacy. As a result, tailoring advertisements to users who do not register or log in to a Web site is more difficult.

Therefore, it would be advantageous to have an improved method, apparatus, and computer instructions for customizing advertising, such as associating an appropriate voice file with an advertisement in a Web page for a user.

### SUMMARY OF THE INVENTION

The present invention provides a method, apparatus, and computer instructions for responding to a request for a Web page. The location of a client is identified in response to a request for a Web page from a client. A voice file is selected for the Web page using the location of the client to form a selected voice file. The selected voice file is associated with the Web page to form a customized Web page; and the customized Web page is sent to the client.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in customizing a Web page with a voice file in accordance with a preferred embodiment of the present invention;

FIG. 5 is an example of a table that may be used to select an audio file in accordance with a preferred embodiment of the present invention;

FIG. 6 is an example of tables used in selecting audio files for regions within a country in accordance with a preferred embodiment of the present invention; and

FIG. 7 is a flowchart of a process for selecting an audio file for a Web page in accordance with a preferred embodiment of the present invention.

### DETAILED DESCRIPTION OF THE PREFERRED EMBODIMENT

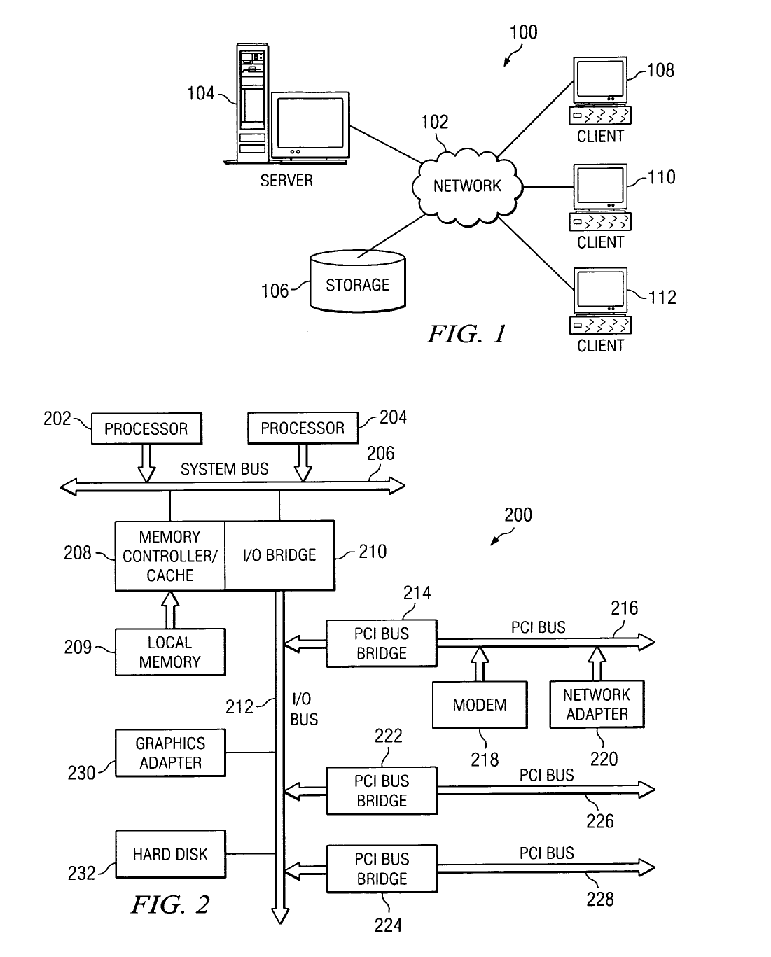

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

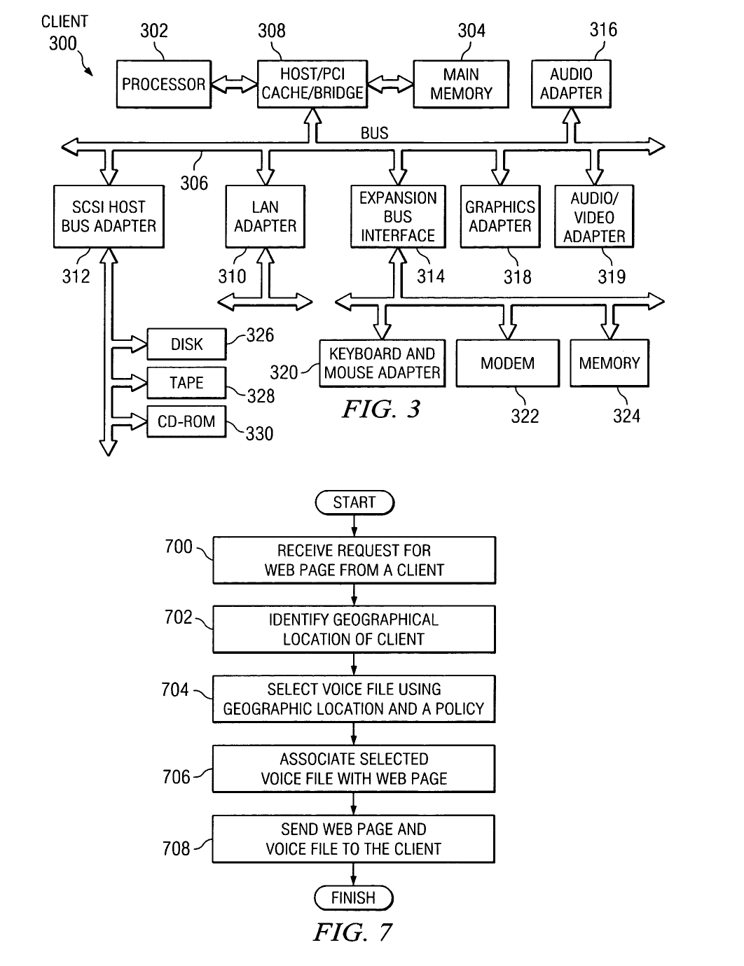

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for tailoring or customizing Web pages with audio files based on a geographic location of the user. In particular, the geographic location is that of the data processing at which the user is located. The mechanism of the present invention allows for selecting an appropriate voice or audio file based on the geographic location of the target client data processing system.

The mechanism of the present invention also allows for an audio selection, such as a voice file, to be associated with content in a Web page based on the geographic location of the data processing system. For example, depending on the location of the data processing system requesting the Web page, a voice file having a particular language such as English or French may be selected. Further, depending on the geographic location, a voice file, having a particular dialect or accent may be selected. Such a feature is especially useful in countries, such as India, which has regions with a multitude of languages and dialects. In these examples, the content is an advertisement.

In this manner, advertisement providers do not need to create customized versions of advertisements for different regions. Instead, the voice file associated with the advertisement may be used to provide the customization for the advertisement. Further, the gender of the voice file may be tailored based on customs and preferences of certain countries.

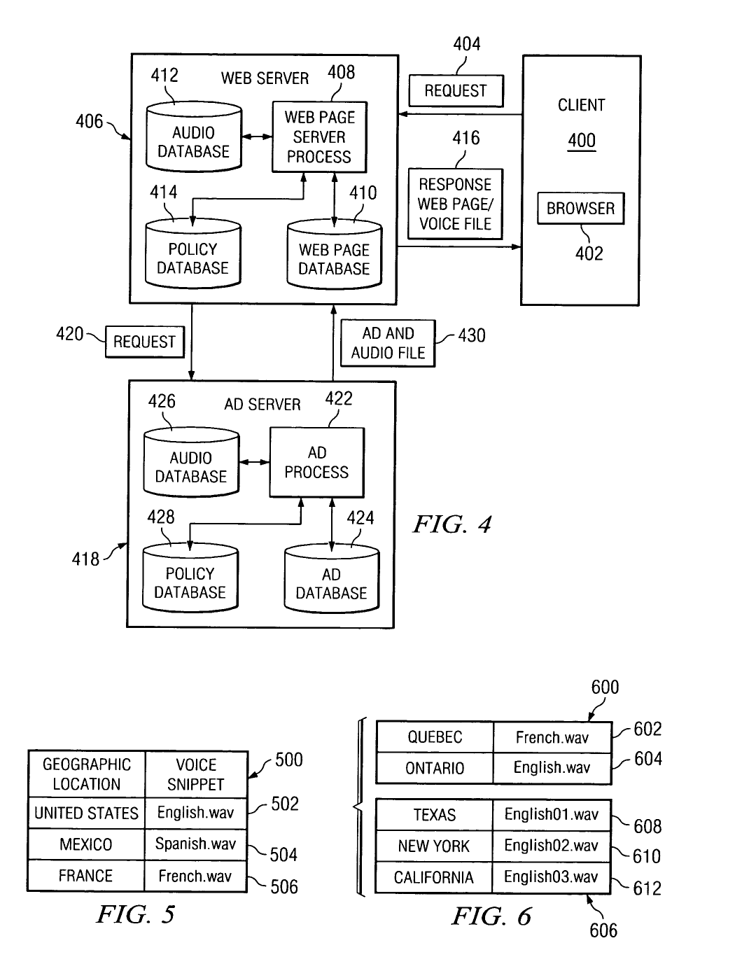

Turning now to FIG. 4, a diagram illustrating components used in customizing a Web page with a audio file is depicted in accordance with a preferred embodiment of the present invention. In this example, client 400 includes browser 402. A user at client 400 generates request 404 through browser 402. Request 404 is received at Web server 406. This request is processed by Web page server process 408. Request 404 is for a Web page from a Web site. The Web page is identified from Web page database 410. This Web page database may be a set of static Web pages or contain data for dynamically constructing Web pages.

In this example, an advertisement may be included within the Web page that is to be returned to client 400. An appropriate audio file is associated with the advertisement in Web page. This audio file is selected from audio database 412. In these examples, the audio file is a voice file for the advertisement. The voice file is selected based on rules within policy database 414. Policy database 414 identifies voice files that are to be used depending on the geographic location of client 400. The geographic location of client 400 is identified from request 404.

When request 404 is generated, an IP address is included in the request identifying client 400. This IP address may be used to identify a geographic location of client 400. In these examples, the geographic location is also referred to as origination information with respect to client 400. As a result, depending on the location of client 400, an appropriate voice file is selected from audio database 412 for inclusion within the Web page. This voice file may use a particular language, dialect, or accent depending on the location of client 400. If a different location is identified for another request in which the same advertisement is to be used, a different voice file may be selected. Thereafter, Web page server process 408 returns response 416, which includes a Web page and a voice file to client 400.

In some cases, the advertisement and the voice file may be obtained from another server, such as ad server 418. In this case, request 420 is forwarded to ad server 418. Request 420 is processed by ad process 422, which identifies the geographic location of client 400. Again, this geographic location may be identified from the IP address of client 400, which is included in request 420. Request 420 is a copy of request 404 received by Web page server process 408.

Ad process 422 selects an appropriate ad from ad database 424 for use in a Web page. Further, an appropriate voice file is selected from audio database 426 using rules in policy database 428. As with the example in which policy database 414 is used, the appropriate voice or other type of audio file is selected from audio database 426 based on the geographic location of the user. These rules may identify different audio files for use depending on the particular location of the user.

For example, if the user is located in France, a voice file with a message in French is employed. If the user is in the United States, a voice file using the English language is included. If the user is in the United Kingdom, a voice file in English with an appropriate English accent is selected. As a result, the same message may be delivered using different languages, dialects, and accents. Additionally, different accents also are found even within a country depending on a particular region.

Further, the mechanism of the present invention may select a particular audio file based on a location or region from where a user originates. This type of information is also referred to as origination information. This information may be stored in a profile for a user and sent to Web page server process 408 within request 404. This profile may be stored at browser 402 at client 400 in association with a particular user.

For example, a student at Harvard, who is from Huntsville, Ala., may grow tired of hearing a Boston accent. As a result with profile information, such as a region of origination or other biographical information, an appropriate voice file with the appropriate accent may be selected. As a result, a voice file with a message that is most likely to be appealing or aesthetically pleasing may be selected for a user for a given region of origination.

The advertisement and audio file 430 is then returned to Web server 406. At that point, Web server process 408 includes the advertisement and audio file 430 into the Web page and returns this Web page in response 416 to client 400.

Turning now to FIG. 5, an example of a table that may be used to select an audio file is depicted in accordance with a preferred embodiment of the present invention. In this example, the policy or rule set up to select audio files may take the form of a table, such as table 500. This table may be located in a policy, such as policy database 414 in FIG. 4.

Table 500 includes entries in which the geographic location is the key to the entries in table 500. In this example, entry 502 has the United States as a geographic location, entry 504 has Mexico as the geographic location, and entry 506 has France as the geographic location. For entries 502, 504, and 506, different voice files are returned depending on the geographic location.

In this example, if the location is Canada, either the French or English language may be used depending on the specific location within the country. In this case, more granularity is needed with respect to the geographic location.

Turning now to FIG. 6, examples of tables used in selecting audio files for regions within a country are depicted in accordance with a preferred embodiment of the present invention. In this example, table 600 includes entry 602 and entry 604. Entry 602 identifies the geographic location in Canada as being in Quebec, while entry 604 identifies Ontario as being the geographic location. If Quebec is the location of the client, a French audio file is selected. On the other hand, if Ontario is the geographic location of the client, an English audio file is selected.

Next, table 606 illustrates entries for states within the United States. In this example, entries 608, 610, and 612 are present. Entry 608 identifies the state as being Texas, entry 610 identifies the state as being New York, and entry 612 identifies the state as being California. In each of these cases, an English language audio file is selected. However, the particular accent is tailored for each geographic location.

The tables illustrated in FIGS. 5 and 6 are presented only as examples of how a policy, such as policy database 414 in FIG. 4 may be implemented. These policies may be implemented using other mechanisms. For example, a database may be used in which the geographic location, or even an IP address is used as the query to identify an appropriate audio file for content in a Web page.

Turning now to FIG. 7, a flowchart of a process for selecting an audio file for a Web page is depicted in accordance with a preferred embodiment of the present invention. The process illustrated in FIG. 7 may be implemented in a server process, such as Web page server process 408 or ad process 422 in FIG. 4.

The process begins by receiving a request for a Web page from a client (step 700). Thereafter, the geographic location of the client is identified from the request (step 702). In these examples, the geographic location may be identified from the IP address. Next, a voice file is selected using the geographic location and a policy (step 704).

The selected voice file is associated with the Web page (step 706). More specifically, the voice file may be associated with a particular piece of content in the Web page. In this example, the voice file is associated with an advertisement on the Web page. Depending on the particular implementation, the voice file may be selected with other types of content other than advertisements. For example, the voice file may be associated with a photograph, graphic image, or text in the Web page. Additionally, other types of audio files other than voice files may be used depending on the particular implementation.

Afterwards, the Web page and the voice file are sent to the client (step 708) with the process terminating thereafter. If this process is implemented in an ad server, the voice file is associated with an advertisement, rather than a Web page. The advertisement and the voice file are then sent back to the Web server for inclusion in the Web page.

Thus, the present invention provides an improved method, apparatus, and computer instructions for associating voice files with Web pages or other documents. The mechanism of the present invention identifies the geographic location of the client and then uses a policy to select an appropriate audio file. In these examples, the audio file is a voice file having an appropriate language, dialect, or accent depending on the particular geographic location of the client. Further, the client's geographic location is identified based on the IP address.

Many services are present to identify a location of a user based on the IP address. In this manner, advertisements may be customized to the geographic location of a user. Further, by selecting a voice or audio file for a particular advertisement or other content, advertisers or content providers do not need to create customized versions of text or graphics for users with the customization being provided through the selection of an appropriate audio file.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally, regardless of the particular type of signal bearing media actually used to carry out the distribution. Examples of computer readable media include: recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for responding to a request for a Web page, the method comprising:
responsive to a request for a Web page from a client, identifying a location of the client;
selecting a voice file for the Web page using the location of the client to form a selected voice file;
associating the selected voice file with the Web page to form a customized Web page; and
sending the customized Web page to the client.

2. The method of claim 1, wherein the location information received in the request from the client.

3. The method of claim 1, wherein the Web page and the selected voice file form an advertisement.

4. The method of claim 1, wherein the method is located in a Web server.

5. The method of claim 1, wherein the location is at least one of a country, state, and province.

6. The method of claim 5, wherein the geographic location is derived from an Internet Protocol address in the request.

7. The method of claim 1, wherein the selecting step comprising:
sending the location of the client to an advertisement server; and
receiving advertisement information and the selected voice file from the advertisement server in response to sending the location of the client to the advertisement server.

8. A method in a data processing system for responding to a request for a Web page, the method comprising:
responsive to a request for a Web page from a client, identifying origination information;
selecting a voice file for the Web page using the origination information to form a selected voice file;
associating the selected voice file with the Web page to form a customized Web page; and
sending the customized Web page to the client.

9. The method of claim 8, wherein the origination information is a region of origination for a user.

10. The method of claim 8, wherein the origination information is used to identify the voice file as being appealing to a user from a given region.

11. The method of claim 9, wherein the voice file uses at least one of a language, dialect, or accent that is most appealing for the region of origination.

12. The method of claim 8, wherein the origination information is stored in a profile

13. A data processing system for responding to a request for a Web page, the data processing system comprising:
identifying means for identifying a location of the client in response to a request for a Web page from a client;
selecting means for selecting a voice file for the Web page using the location of the client to form a selected voice file;
associating means for associating the selected voice file with the Web page to form a customized Web page; and
sending means for sending the customized Web page to the client.

14. The data processing system of claim 13, wherein the selecting means comprises:
sending means for sending the location of the client to an advertisement server; and
receiving means for receiving advertisement information and the selected voice file from the advertisement server in response to sending the location of the client to the advertisement server.

15. A data processing system comprising:
a bus system;
a memory connected to the bus system, wherein the memory includes a set of instructions; and
a processing unit connected to the bus system, wherein the processing unit executes the set of instructions to identify a location of the client in response to a request for a Web page from a client; select a voice file for the Web page using the location of the client to form a selected voice file; associate the selected voice file with the Web page to form a customized Web page; and send the customized Web page to the client.

16. A computer program product in a computer readable medium for responding to a request for a Web page, the computer program product comprising:
first instructions for identifying a location of the client in response to a request for a Web page from a client;
second instructions for selecting a voice file for the Web page using the location of the client to form a selected voice file;
third instructions for associating the selected voice file with the Web page to form a customized Web page; and
fourth instructions for sending the customized Web page to the client.

17. The computer program product of claim 16, wherein the location information received in the request from the client.

18. The computer program product of claim 16, wherein the Web page and the selected voice file form an advertisement.

19. The computer program product of claim 16, wherein the method is located in a Web server.

20. The computer program product of claim 16, wherein the second instructions comprising:
first sub instructions for sending the location of the client to an advertisement server; and
second sub instructions for receiving advertisement information and the selected voice file from the advertisement server in response to sending the location of the client to the advertisement server.
